(19) United States
(12) Patent Application Publication
(10) Pub. No.: US 2005/0075432 A1
(43) Pub. Date: Apr. 7, 2005

(54) Acidulent film and method of making same

(76) Inventors: Andrew P. Verrall, Crown Point, IN (US); Vimala Francis, Valparaiso, IN (US); Laura Moss, Schereville, IN (US); Karen Kugler, Porter, IN (US)

Correspondence Address: HOFFMANN & BARON, LLP, 6900 JERICHO TURNPIKE, SYOSSET, NY, 11791, US

(21) Appl. No.: 10/680,441

(22) Filed: Oct. 7, 2003

(51) Int. Cl. C08K 3/24; C08K 5/09

(52) U.S. Cl. 524/284; 524/401

(57) ABSTRACT

A composition for oral administration, including an acidulent, water-soluble film, and methods of making the film, are disclosed.

### BACKGROUND

1. Field of the Disclosure

The disclosure relates generally to water-soluble films. More particularly, the disclosure relates to acidulent films.

2. Brief Description of Related Technology

Water-soluble films have many applications, including non-edible forms, such as packaging materials, and edible forms, wherein the film itself is or makes up an edible article. Edible films are known for uses such as delivery of therapeutic agents, breath freshening agents, and flavors.

Candies delivering flavor components and sour taste are known. Examples of form factors include solid balls, lentils, gums, lollipops, liquids, and powders.

### SUMMARY

One aspect of the disclosure provides an acidulent, water-soluble film.

Another aspect of the disclosure provides a water-soluble film, including a water-soluble film-forming agent and an acidulent system including an acidulent selected from the group consisting of organic acids, salts of organic acids, inorganic acids, salts of inorganic acids, and combinations thereof, provided that when the organic acids are present in an amount of 12 wt. % or less that the acidulent system further includes one or more of a salt of an organic acid, an inorganic acid, and a salt of an inorganic acid.

Still another aspect of the disclosure provides a method of making an acidic, water-soluble film including disposing a composition including one or more acids (e.g., a powder or a liquid mist) onto a layer of dried or semi-dried water-soluble film, and applying a second layer of water-soluble film on top of the first film layer.

Further aspects and advantages may become apparent to those skilled in the art from a review of the following detailed description. While the film is susceptible of embodiments in various forms, the description hereafter includes specific embodiments with the understanding that the disclosure is illustrative, and is not intended to limit the invention to the specific embodiments described herein.

### DETAILED DESCRIPTION

The base component for the film is a film-forming agent. The film-forming agent aids in providing structure and continuity to the composition to form a film. A film-forming agent generally is included in a range of about 10% to about 90%, preferably about 20% to about 60%, more preferably about 30% to about 50% by weight of the film (wt. %). Film forming agents that can be used in the film include, but are not limited to, alginates, cellulose ethers, edible polymers, land plant extracts, natural and synthetic gums, proteins, seaweed extracts, starches and modified starches, other saccharides and polysaccharaides, derivatives thereof, and combinations of any of the foregoing.

Examples of alginates include salts of alginic acid (e.g., calcium alginate, sodium alginate, potassium alginate) and esterified alginates such as propylene glycol alginate. Propylene glycol alginate is a partially-esterified alginic acid in which some of the carboxyl groups are esterified with propylene glycol, some are neutralized with an appropriate alkali and some remain free. Low viscosity sodium alginate is preferred. In addition to its ease of hydration and film-forming capability by intermolecular association, sodium alginate, with its neutral odor and taste helps in the release of incorporated flavors.

Examples of cellulose ethers include carboxymethyl cellulose (CMC), ethyl cellulose, hydroxyethyl cellulose, hydroxypropyl cellulose (HPC), methyl cellulose (MC), methyl ethyl cellulose, methylhydroxy cellulose (MHC), methyl hydroxypropyl cellulose (MHPC, also hydroxypropyl methyl cellulose HPMC), microcrystalline cellulose (MCC), and derivatives thereof. Examples of edible polymers include polyethylene oxide (PEO), polyvinyl alcohol (PVA or PVOH), polyvinyl pyrrolidone (PVP), and derivatives thereof.

Examples of natural and synthetic gums include carrageenan, gum ghatti, gum arabic, gum acacia, karaya gum, locust bean gum, gum tragacanth, guar gum, tamarind gum, xanthan gum, scleroglucans, and derivatives thereof. Examples of land plant extracts include konjac, arabinoglactan, and derivatives thereof. Examples of proteins include casein, whey protein, and zein.

Examples of starches and modified starches include acid and enzyme hydrolyzed corn and potato starches, dextrins, amylopectin, and derivatives thereof. Examples of other saccharides and polysaccharaides include dextrans, pectins, bacterial polysaccharides (e.g., pullulan), and derivatives thereof. It will be understood by those of ordinary skill in the art, in view of the teaching herein, that other natural and synthetic edible materials can be used which possess the desirable film-forming properties of the composition described herein.

Preferred film forming agents include salts of alginic acid, esterified alginates, pectin, non-ionic cellulose ethers such as MHPC and HPC, and combinations thereof.

An acidic component can be added to the film for a variety of reasons. In a preferred embodiment, the film is edible, and contains an effective amount of one or more acidulents to provide the film with a pronounced sour taste. For example, the film can include a first acidulent to deliver an initial sour impact, and a second acidulent to augment the sour taste with smooth and prolonged tartness. One or more acidulents can be used to enhance a flavor component (e.g., fruit flavors), either in addition to or instead of a primary function for sour taste delivery. Acidulents can be selected from organic and inorganic acids, and salts thereof.

Examples of acidulents for use in edible films for sour flavor include, but are not limited to organic mono- or multi-carboxylic acids which provide a sour or tart sensation, such as C₂ to C₁₂ organic mono- or multi-carboxylic acids (e.g., acetic, lactic, malic, fumaric, succinic, tartaric, adipic, citric, sorbic, ascorbic (including isoascorbic or erythorbic) and gluconic (including glucono-delta lactone)); salts of such organic acids (e.g., ammonium citrate, calcium citrate, magnesium citrate, potassium citrate, sodium citrate, trisodium citrate, tripotassium citrate, ammonium lactate, calcium lactate, potassium lactate, sodium lactate, magnesium lactate, manganese lactate, potassium sodium tartrate, potassium-L-bitartarate, potassium gluconate, sodium erythorbate, and sodium gluconate); inorganic acids (e.g., phosphoric acid, pyrophosphoric acid, hydrochloric acid, sulfuric acid, carbonic acid); and salts of inorganic acids (e.g., alkali metal bisulfates such as sodium bisulfate and potassium bisulfate); and combinations of the foregoing.

In one embodiment, the film includes one or more organic acids as acidulents. Citric acid is preferred for delivery of an initial sour impact. Malic acid is preferred for augmenting the sour taste and providing smooth and prolonged tartness. Small amounts of lactic acid (e.g., 2 wt. % or less) are preferred for delivering an additional boost to flavors.

In a preferred candy embodiment, the film will include an effective amount of one or more acidulents to render the film a sour taste. Sourness is proportional to the particular acidulent used, the overall pH, and the concentration of the acidulent used. Organic acids that are more hydrophilic (e.g., citric and tartaric) have a sourness sensation that dissipates quickly. The less hydrophilic acids (e.g., acetic, fumaric, lactic, and malic) deliver a more persistent sour taste. In one type of embodiment, the sour film includes at least two different acidulents. For example, one embodiment includes citric acid and malic acid, preferably in a ratio of about 7:1 to about 2:1, respectively, to deliver an initial sour impact transitioning to a smooth, prolonged sour taste. The ratio of citric acid to malic acid can depend, in part, on the particular flavors used.

Alkali metal bisulfates (e.g., sodium bisulfate) are more acidic than most organic acids, and so less concentration is required to attain a lower pH and/or more sour taste. For example, alkali metal bisulfates can be used in an amount from as little as about 0.005 wt. % or about 0.01 wt. % (e.g., sodium bisulfate), to about 1 wt. % or up to 10 wt. %.

The amount of organic acids, when used alone in the film or with acids of comparable strength, preferably is greater than 12 wt. %, and preferably about 45 wt. % or less, for example in a range of about 20 wt. % to about 37 wt. %. In one embodiment, the film includes a high concentration of weak acids, such as at least 20 wt. % of weak organic acids and salts thereof. The film former is typically the main component of the film, but in very sour films the amount of acid(s) can equal or exceed the amount of film former in the composition.

The acid components (e.g., organic acids) can exert an excessive plasticizing action on film. The plasticizing effect can be exacerbated by the hygroscopicity of some of the acids, resulting in adherence between films (e.g., when layered for storage and use).

Another challenge that can be created by a film having high acids content is a relatively low pH (e.g., pH less than 6, or less than 5) of the solution from which the film is made (and, likewise, of any solution or suspension resulting from adding water to the film). For example, solutions from which films described in the examples below were prepared have pH values in the range of about 2 to 4. Accordingly, another aspect of the disclosure is an acid-containing film having a low pH, such as in the range of about 2 to about 4, or about 2 to about 3.5, when combined with water (e.g., at least sufficient water to provide a pH measurement, or filly dissolved). In one embodiment, a sour, edible film will have a pH of about 2.6 to about 4.6.

In very low pH environments (e.g., pH less than 3), salts of alginic acid, such as sodium alginate, are converted to insoluble free acid forms. Strong interactions between carboxylic acid groups of the alginic acid polysaccharide result in a net increase in formulation viscosity at room temperature. Although the resulting alginate solutions do show a reversible viscosity decrease with increasing temperature, the higher viscosity at room temperature can lead to solution handling and processing issues. In addition, the low pH combined with elevated temperatures can lead to hydrolytic degradation of the alginate.

Gelation of the alginate formulations can also be caused by multivalent ions, which can be inadvertently incorporated into the film compositions via commercial-grade formulation components (e.g., gum arabic, cross-linked sodium carboxymethyl cellulose, and sodium alginate itself). For example, divalent ions can bind between carboxylic acid groups of alginate chains, resulting in strong chain interactions and increased formulation viscosity.

The various embodiments of the film described herein address the issues described above in various ways.

In one embodiment, the film includes a reversible or irreversible sequestrant to bind multivalent ions, thereby preventing their interaction with carboxylic acid groups on alginate film formers. Sequestrants include, but are not limited to, calcium acetate, calcium chloride, calcium citrate, calcium diacetate, calcium gluconate, calcium hexametaphosphate, calcium phosphate monobasic, calcium phytate, citric acid, dipotassium phosphate, disodium phosphate (DSP), isopropyl citrate, monoisopropyl citrate, potassium citrate, sodium acid phosphate, sodium citrate (optimal pH range 4-10), sodium diacetate, sodium gluconate, sodium hexametaphosphate (SHMP; optimal pH range 2-9), sodium metaphosphate, sodium phosphate, sodium potassium tartrate, sodium pyrophosphate, sodium pyrophosphate, tetra sodium tartrate, sodium thiosulfate, sodium tripolyphosphate (STPP; optimal pH range 3-8), stearyl citrate, and tartaric acid.

Although sequestrant salts can modify pH (e.g., sodium citrate, in some of the examples below, elevates the pH of the film to above 3.0, which results in a partial conversion of insoluble alginic acid to the soluble sodium salt), when used with alginic acid film-formers they are preferably used for their ion-binding ability.

Preferred sequestrants include phosphoric and citric acid salts, including: sodium citrate, sodium aluminum phosphate (SALP), monosodium phosphate (MSP), DSP, trisodium phosphate (TSP), tetrasodium tripolyphosphate (TSTPP), STPP, SHMP, and insoluble metaphosphate (IMP). The phosphates can also provide other functions, such as emulsification and stabilization. All of these salts have a natural tendency to bind multivalent ions such as calcium. The sodium and calcium salts of EDTA (ethylenediaminetetraacetic acid) are common sequestrants. TSTPP, STPP and SHMP all bind relatively strongly. Sequestrants which have an inherent acidic taste and can contribute to the sour taste of acidulent films, such as sodium citrate, are preferred. SHMP can result in a considerable reduction of alginate formulation viscosity at room temperature. SHMP also provides amplification of flavor impact even at low levels (e.g., 1 wt. %).

One or more sequestrants are preferably used in an amount in a range of about 0 wt. % to about 6 wt. %, more preferably about 1 wt. % to about 4 wt. %.

In another embodiment, the primary film former is an esterified alginate. As described above, alternate alginate film formers, such as propylene glycol alginate, having a lower concentration of carboxylic acid groups (e.g., esterification degree 78% to 85%), and greater acid and multivalent ion tolerance, can be used to prepare films with high acid content, such as sour acidulent films. Esterified alginate films are particularly effective in the pH range of about 2.5 to about 4. In addition to being a primary film former, propylene glycol alginate can also serve as a stabilizer, thickener, and emulsifier. Furthermore, the hydrophobicity of propylene glycol alginate can retard moisture absorption by the film.

The use of non-ionic film formers, such as cellulosics (e.g., MHPC, HPC) with no carboxylic acid groups in the polymer chains also circumvents the challenges associated with ionic film formers (e.g. sodium alginate, carboxymethyl cellulose, pectin) in low-pH and multivalent ion environments. Salts of alginic acid are preferred because films based on esterified alginates and non-ionic film formers generally have a reduced rate of dissolution compared to those based solely or largely on salts of alginic acid. Pectin-based formulations can yield good films with good flavor retention, however, they tend to have a high viscosity at room temperature and generally require warming before processing. The MHPC/alginate blends and MHPC-based formulations described herein are more resistant to gel formation at room temperature and offer a significant advantage for processing.

The issue of film adherence between layers of film can be addressed by incorporating one or more suitable glidants. Suitable glidants (also called anti-adherents) include, but are not limited to, glyceryl monostearate, fumed silica, talc, silica hydrogel, and waxes. Carnauba wax is preferred. In addition, without intending to be limited to any particular theory, in a film based on hydrophilic film formers such as alginates, the incorporation of a wax such as carnauba wax is believed to decrease film permeability to moisture and film dehydration over time.

In one embodiment, the film includes a disintegrant. Disintegrants can aid in controlling the rate of dissolution of the film, or portions thereof, generally so that the efficacy of the film can be realized sooner. Suitable disintegrants for use in the film include, but are not limited to, alginic acid, MCC, CMC, carboxymethyl starches, carboxymethyl starch sodium, low substituted HPC, and pectins.

Disintegrants known as super-disintegrants are suitable for use in the film. Super-disintegrants include crospovidone, sodium starch glycolate, and croscarmellose, which represent examples of a cross-linked polymer, a cross-linked starch, and a cross-linked cellulose (modified carboxymethylcellulose), respectively. Additional and specific examples include carboxymethyl cellulose calcium, sodium carboxymethyl cellulose (i.e., carmellose sodium), crosslinked sodium carboxymethyl cellulose (i.e., croscarmellose sodium). Crosslinked sodium carboxymethyl cellulose is preferred. These super-disintegrants are insoluble in water and most other solvents, have rapid swelling properties, and have good water uptake with high capillary action which results in fast disintegration. The components break the film down into small fragments having larger surface areas, which can result in increased dissolution rates for the film. These components can be used even in low concentrations. A disintegrant (including super-disintegrants) preferably is used in an amount from about 1 wt. % to about 10 wt. %, more preferably about 1 wt. % to about 5 wt. %.

Edible forms of the acid film preferably include one or more flavorants. A variety of flavorants can be used within the film. Examples of such flavorants include, but are not limited to, artificial flavorants, flavor oils, flavoring aromatics, extracts derived from plants, leaves, flowers, fruits, derivatives thereof, and combinations thereof. Artificial flavors which may be suitable for use include vanilla, chocolate, coffee, cocoa, citrus oil (lemon, lime, orange, grape, grapefruit), fruit essences (apple, pear, peach, strawberry, raspberry, cherry, plum, pineapple, apricot, watermelon), derivatives thereof, and combinations thereof. More generally, any flavoring or food additive described in Chemicals Used in Food Processing, publication 1274 by the National Academy of Sciences, pages 63-258, may be suitable for use.

Suitable examples of aldehyde flavorings include, but are not limited to acetaldehyde (apple), benzaldehyde (cherry, almond), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2-6-dimethyloctanal (green fruit), and 2-dodecenal (citrus, mandarin), cherry, grape, cinnamic aldehyde (cinnamon), citral, i.e., alpha citral (lemon, lime), neral, i.e., beta citral (lemon, lime), decanal (orange, lemon), ethyl vanillin (vanilla, cream), heliotropine, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), derivatives thereof, and combinations thereof.

The amount of flavoring used is a matter of design preference, and can also depend on the combination of flavor components that have been selected for use in the film. Determining suitable ranges for each flavoring agent is well within the capabilities of one of ordinary skill in the art without the need for undue experimentation, in view of the disclosure herein. Commercially-supplied flavorants can sometimes include non-flavor components, such as lactic acid and sweeteners, which should be accounted for. Generally, the amount of one or more flavoring agents used in the film will range from 0 wt. % to about 40 wt. %, preferably about 10 wt. % to about 30 wt. %, more preferably about 15 wt. % to about 20 wt. %.

Coloring agents can be used to provide the film with a more enticing appearance. In addition, a relatively high concentration of coloring agent can be used in an edible film to provide a relatively persistent stain on the tongue of the user. Examples of coloring agents useful in the film include pigments such as titanium dioxide and natural food colors and dyes suitable for food, drug, and cosmetic applications. The latter coloring agents are known as FD&C dyes and lakes. A full description of all FD&C and D&C dyes and their corresponding chemical structures can be found in Kirk-Othmer Encyclopedia of Chemical Technology, Volume 5, pages 857-884. Coloring agents generally will be used in the film in a range from 0 wt. % to about 0.4 wt. %. To simply color the film and potentially provide a relatively short-lived stain to the tongue of the user, one or more coloring agents preferably will be used in an amount up to about 0.1 wt. %, more preferably about 0.02 wt. % to about 0.06 wt. %. In an embodiment desired to provide a persistent stain to the tongue of the user, one or more coloring agents, preferably dyes, preferably will be used in an amount at least about 0.1 wt. %, for example in a range of about 0.2 wt. % to about 0.3 wt. %.

The film preferably includes one or more sweeteners. Sweeteners can substantially contribute to fruit flavor delivery from the film. Sweeteners for the film include those well known in the art for sweetening edible compositions. Examples of such sweeteners include, but are not limited to, sucralose, sorbitol, aspartame, acesulfame (e.g., K-acesulfame or acesulfame potassium), dextrose, maltose, fructose, corn syrup, other water soluble sweetening agents, other water soluble artificial sweeteners, dipeptide based sweeteners, protein based sweeteners, derivatives thereof, and combinations thereof. The amount of sweetener provided will vary with the specific sweetener and/or flavors used to provide the desired sweetness, and can be determined via routine optimization by a person of ordinary skill. Preferred sweeteners for use in the film include aspartame and K-acesulfame, because of their ability to bring out flavor and taste in the sour films, without making the film too sweet. The sweetener preferably is used in an amount in a range of 0 wt. % to about 1 wt. %, more preferably about 0.2 wt. % to about 0.5 wt. %.

To optimize the processing of the film, the film composition preferably includes one or more emulsifiers, emulsion stabilizers, surfactants, and combinations thereof. Some chemicals typically used for such purposes can have multiple functions, as described below.

Emulsifiers are preferably oil-in-water emulsifiers. Emulsifiers suitable for use in the edible film include, but are not limited to, gum arabic, gum karaya, polyoxyethylene sorbitan esters (e.g., polysorbate 80), lecithins, mono- and diglycerides, propylene glycol monoesters, polyglycerol esters, sucrose esters, sucinylated esters, derivatives thereof, and combinations thereof. A preferred emulsifier is gum arabic, and is preferably used in an amount from about 0 wt. % to about 10 wt. %, more preferably about 3 wt. % to about 5 wt. %.

Examples of suitable stabilizing agents include, but are not limited to, gum arabic, microcrystalline cellulose, carrageenan, xanthan gum, locust bean gum, derivatives thereof, and combinations thereof. The preferred stabilizing agents are microcrystalline cellulose and gum arabic. Microcrystalline cellulose is odorless and tasteless, imparts superior suspension stability to the formulation, aids in rapid film disintegration, enhances mouth feel, and also acts as a viscosity regulator and modifier.

Emulsifiers and stabilizers can also contribute to flavor fixation. For example, the use of gum arabic substantially enhances the overall flavor of edible sour films. Gum arabic has a neutral taste and bland flavor. Without intending to be limited to any particular theory, gum arabic is believed to contribute to flavor encapsulation (e.g., via an oil-in-water emulsion), retention of volatile flavor components, stabilization of flavor emulsions, and protection of flavors from oxidation. In addition to its high water solubility, acid stability, and low hygroscopicity, gum arabic can also function as a texturizer, low viscosity water binder, and film former.

One or more emulsifiers, stabilizers, and surfactants can be used in amounts ranging from about 0 wt. % to about 25 wt. %, more preferably about 0 wt. % to about 16 wt. %.

Suitable surfactants include, but are not limited to, pluronic acids, sodium lauryl sulfate, mono- and diglycerides of fatty acids, polyoxyethylene fatty acid esters, and sorbitan fatty acid esters (polysorbates), such as Polysorbate 80, derivatives thereof, and combinations thereof. The surfactants can be present in amounts ranging from about 0 wt. % to about 10 wt. %, more preferably about 1 wt. % to about 5 wt. %. Non-ionic surfactants, including polyoxyethylene sorbitan monooleate, are preferred.

Compounds which can act as emulsifiers, stabilizers, and surfactants to varying degrees include acetic, lactic, and fatty acid esters of glycerol, lecithins, polyoxyethylene fatty acid esters, sorbitan fatty acid esters (polysorbates), propylene glycol fatty acid esters, polyoxyethylene lauryl ether, polyoxyethylene cetyl ether, and ionic surfactants such as sodium dodecyl sulfate and benzalkonium chloride.

Other additives that can be incorporated into the film include, but are not limited to, antioxidants, binding agents, buffers, bulk fillers, cooling agents, fragrances, humectants, lubricants, mouth feel improvers, plasticizers, preservatives, thickening agents, and combinations thereof, e.g., used for their known properties.

A plasticizing agent can be used to improve flexibility and reduce brittleness of the film. A plasticizing agent preferably is used in an amount of about 0 wt. % to about 30 wt. %, more preferably about 0 wt. % to about 15 wt. %. Examples of suitable plasticizing agents include, but are not limited to, glycerin, sorbitol, triacetin, monoacetin, diacetin, polyethylene glycol, propylene glycol, hydrogenated starch hydrolysates, corn syrups, derivatives thereof, and combinations thereof. Preferred plasticizing agents include sorbitol, glycerin, and propylene glycol.

Oral care agents can be used to help reduce oral malodor as well as act as antimicrobial agents. Examples of suitable oral care agents include, but are not limited to, caries control agents such as phosphates and fluorides, anti-plaque and anti-gingivitis agents such as cetylpyridinium chloride and triclosan, germ killing agents, and sulfur precipitating agents such as metal salts.

Examples of suitable breath freshening agents include, but are not limited to, spearmint oil, peppermint oil, other mint oils, oil of wintergreen, zinc gluconate, citrus oils, fruit essences, clove oils, anise, menthol, eucalyptol, thymol, methyl salicylate, derivatives thereof, and combinations thereof.

A bulk filler agent can used to reduce the potential for oily texture of the film. A bulk filler agent can be used in an amount from about 0 wt. % to about 25 wt. % more preferably about 3 wt. % to about 15 wt. %. Suitable bulk filler agents include, but are not limited to, MCC, magnesium carbonate, calcium carbonate, calcium phosphate, calcium sulfate, magnesium silicate, aluminum silicate, ground lime stone, clay, talc, titanium dioxide, cellulose polymers such as wood, derivatives thereof, and combinations thereof.

Suitable lubricants include, but are not limited to, magnesium stearate, colloidal silica, talc, calcium stearate, stearic acid, hydrogenated vegetable oils, magnesium lauryl sulfate, glyceryl monostearate, waxes, polyethylene glycols, leucine, and lecithins.

Suitable mouth feel improvers include, but are not limited to, microcrystalline cellulose and carrageenan.

Suitable cooling agents include monomenthyl succinate, WS3, WS23, Ultracool II and the like.

Fragrances can be used to enhance the appeal of the product as necessary. Any fragrance suitable for use in edible products, such as fruit and mint oils, can be used in the film.

Thickening agents can be used for enhancing the structure of the edible film. Suitable thickening agents include, but are not limited to, methylcellulose, carboxylmethylcellulose, derivatives thereof, and combinations thereof.

To improve shelf life, preservatives may be used in the film. Suitable preservatives such as potassium sorbate and sodium benzoate can be used in the range from about 0 wt. % to about 5 wt. %, preferably 0 wt. % to about 2 wt. %. Generally, the lower the pH of the film in the wet state, the less preservative that will be required.

Edible, sour, flavored films (such as those in the examples below) can be tailored to provide a smooth transition from an initial pronounced sour taste, to a blend of sour taste and flavor, to a final flavor. The films offer quick dissolution in the mouth so as to deliver the entire effect to the user in a few seconds. Although the films dissolve rapidly, the sourness and flavor do not dissipate quickly.

An embodiment of a sour film includes a water-soluble film-forming agent, an acidulent system, a flavorant, and a sweetener. Such a film preferably includes a wax and one or more emulsifiers, emulsion stabilizers, surfactants, and combinations thereof and, optionally, a disintegrant. Such components can be used in the amounts described above.

An embodiment of an edible, sour, candy film includes a water-soluble film-forming agent, an effective amount of at least two acidulents to provide a sour taste, a fruit flavor, and a sweetener. Such components can be used in the amounts described above.

A particular edible, sour, flavored film includes sodium alginate, Tween 80, MCC, gum arabic, one or more sequestrants (preferably sodium citrate and/or SHMP), carnauba wax, citric acid, malic acid, lactic acid, cross-linked sodium CMC, a sweetener, a flavorant, and a colorant. Such components can be used in the amounts described above.

The film generally can be made by typical film-making procedures known to those of skill in the art or later-developed for making films, such as mixing the components described herein with a suitable solvent, casting a film, and evaporating the solvent. To prevent inadvertent degradation of the alginate, when used, due to combined temperature and pH effects during processing conditions, preferably the acids are mixed into the formulations at low temperatures. The temperature preferably is less than 40° C. Formulations having low pH preferably are also processed at low temperatures and mixed rapidly, to use the minimum mixing time necessary to get the acid in solution, to avoid possible polymer degradation.

An additional sour boost can be imparted by disposing (e.g., spraying) a composition including one or more acids (e.g., a powder or a liquid mist) onto a layer of dried or semi-dried film, and applying a second layer of film on top of the first film layer. The second layer can be cast on top of the first film and acid layer, or pre-cast and dried or semi-dried before application.

### EXAMPLES

The following examples are provided for illustration and are not intended to limit the scope of the invention.

### Example 1

Films according to formulations A through L in Tables 1 and 2 below were made by mixing the identified components in the ratios shown with a water solvent, casting films, and then drying off the water.

TABLE 1

| Components | A | B | C | D | E | F |
|---|---|---|---|---|---|---|
| Sodium Alginate | 30.36 | 37.86 | 43.36 | | 29.34 | |
| Propylene Glycol Alginate | | | | | | |
| Croscarmellose sodium | | | | 1.5 | | |
| Pectin LM 12CG | | | | | | |
| MHPC E 15 | | | | 30.84 | | |
| MHPC E 50 | | | | | | 49.82 |
| Polysorbate 80 | 2.0 | 2.0 | 2.0 | 2.0 | 2.0 | 2.0 |
| Glycerin | 3.0 | 3.0 | 3.0 | | 3.0 | |
| Aspartame | 0.33 | 0.33 | 0.33 | 0.33 | 0.33 | 0.33 |
| Acesulfame-K | 0.11 | 0.11 | 0.11 | 0.11 | 0.11 | 0.11 |
| Potassium sorbate | 0.04 | 0.04 | 0.04 | 0.05 | 0.04 | 0.05 |
| Sodium benzoate | 0.04 | 0.04 | 0.04 | 0.05 | 0.04 | 0.05 |
| Microcrystalline cellulose | 5.0 | 5.0 | 5.0 | 5.0 | 5.0 | |
| Gum Arabic | 4.0 | 4.0 | 4.0 | 4.0 | 4.0 | 4.0 |
| Sodium Citrate | 3.0 | 2.5 | 2.0 | | | |
| SHMP | | | | | 3.0 | |
| Magnesium Stearate | | | | | | 2.0 |
| Amorphous silica | | | | | | 1.5 |
| Carnauba wax | 5.0 | 5.0 | 5.0 | 5.0 | 5.0 | |
| Citric acid | 24.0 | 20.0 | 15.0 | 24.0 | 23.0 | 20.0 |
| Malic acid | 8.0 | 5.0 | 5.0 | 12.0 | 10.0 | 5.0 |
| Lactic acid | 0.10 | 0.10 | 0.10 | 0.10 | 0.10 | 0.10 |
| Green Apple flavor | 15.0 | 15.0 | 15.0 | 15.0 | 15.0 | 15.0 |
| Blue Raspberry flavor | | | | | | |
| Watermelon flavor | | | | | | |
| Dyes | 0.04 | 0.04 | 0.04 | 0.02 | 0.04 | 0.04 |

TABLE 2

| Components | G | H | I | J | K | L |
|---|---|---|---|---|---|---|
| Sodium Alginate | | 28.85 | | | 30.84 | 28.84 |
| Propylene Glycol | | | 30.35 | 33.35 | | |
| Alginate | | | | | | |
| Croscarmellose | | 1.5 | | | 1.5 | |
| sodium | | | | | | |
| Pectin LM 12CG | 46.42 | | | | | |
| MHPC E 15 | | | | | | |
| MHPC E 50 | | | | | | |
| Polysorbate 80 | 2.0 | 2.0 | 2.0 | 2.0 | 2.0 | 2.0 |
| Glycerin | 5.0 | 3.0 | 3.0 | | | 3.0 |
| Aspartame | 0.33 | 0.33 | 0.33 | 0.33 | 0.33 | 0.33 |
| Acesulfame-K | 0.11 | 0.11 | 0.11 | 0.11 | 0.11 | 0.11 |
| Potassium sorbate | 0.05 | 0.05 | 0.05 | 0.05 | 0.05 | 0.05 |
| Sodium benzoate | 0.05 | 0.05 | 0.05 | 0.05 | 0.05 | 0.05 |
| Microcrystalline | | 5.0 | 5.0 | 5.0 | 5.0 | 5.0 |
| cellulose | | | | | | |
| Gum Arabic | 4.0 | 4.0 | 4.0 | 4.0 | 4.0 | 4.0 |
| Sodium Citrate | | | | | | |
| SHMP | | | | | | |
| Magnesium Stearate | 2.0 | | | | | |
| Amorphous Silica | | | | | | |
| Carnauba wax | | 5.0 | 5.0 | 5.0 | 5.0 | 5.0 |
| Citric acid | 20.0 | 20.0 | 20.0 | 20.0 | 20.0 | 25.0 |
| Malic acid | 5.0 | 10.0 | 10.0 | 10.0 | 11.0 | 10.0 |
| Lactic acid | | 0.10 | 0.10 | 0.10 | 0.10 | 0.10 |
| Green Apple flavor | 15.0 | | | | | |
| Blue Raspberry flavor | | 20.0 | 20.0 | 20.0 | | |
| Watermelon flavor | | | | | 20.0 | 15.0 |
| Dyes | 0.04 | 0.053 | 0.053 | 0.053 | 0.02 | 0.02 |

The films provide a smooth transition from an initial sour taste, to a blend of sour taste and fruit flavor, to a final predominantly fruit flavor. The films offer quick dissolution in the mouth so as to deliver the entire effect to the user in a few seconds. Although the films dissolve rapidly, the sourness and flavor do not dissipate quickly.

The foregoing description is given for clearness of understanding only, and no unnecessary limitations should be understood therefrom, as modifications within the scope of the invention may be apparent to those having ordinary skill in the art. Throughout the specification, where compositions are described as including components or materials, it is contemplated that the compositions can also consist essentially of, or consist of, any combination of the recited components or materials, unless described otherwise.

1. A water-soluble film, comprising a water-soluble film-forming agent and an acidulent system comprising an acidulent selected from the group consisting of an organic acid, a salt of an organic acid, an inorganic acid, of a salt of an inorganic acid, and combinations thereof, wherein said acidulent system further comprises one or more of:
(a) at least 25 wt. % organic acid, and
(b) one or more of a salt of an organic acid, an inorganic acid, and a salt of an inorganic acid.

2. The film of claim 1, wherein said acidulent system is present in an amount greater than 0.01 wt. %.

3. The film of claim 2, wherein said acidulent system is present in an amount from about 1 wt. % to about 45 wt. %.

4. The film of claim 1, wherein said acidulent system comprises a salt of an organic acid, present in an amount from about 1 wt. % to about 45 wt. %.

5. The film of claim 1, wherein said acidulent system comprises one or more of an inorganic acid, a salt of an inorganic acid selected from alkali metal bisulfates, and mixtures thereof.

6. The film of claim 5, wherein said acidulent system is present in an amount from about 0.005 wt. % to about 10 wt. %.

7. The film of claim 1, wherein said acidulent comprises one or more acids and salts selected from the group consisting of acetic acid, lactic acid, malic acid, fumaric acid, succinic acid, tartaric acid, adipic acid, citric acid, sorbic acid, ascorbic acid, isoascorbic acid, erythorbic acid, gluconic acid, glucono-delta lactone, phosphoric acid, pyrophosphoric acid, hydrochloric acid, sulfuric acid, salts of the foregoing, alkali metal bisulfates, and combinations thereof.

8. The film of claim 1, wherein said acidulent comprises citric acid and malic acid in a ratio from 7:1 to 2:1, respectively.

9. The film of claim 1, having a pH less than 6.

10. The film of claim 9, having a pH from 2 to less than 4.6.

11. The film of claim 1, wherein the film-forming agent comprises a polymer selected from the group consisting of alginates, cellulose derivatives, pectin, and combinations thereof.

12. (canceled)

13. The film of claim 29, wherein the sequestrant comprises a salt of phosphoric acid or a salt of citric acid.

14. (canceled)

15. The film of claim 35, wherein the ester of alginic acid is propylene glycol alginate.

16. The film of claim 1, wherein the film-forming agent comprises a non-ionic film-forming agent.

17. The film of claim 16, wherein the non-ionic film-forming agent comprises one or both of MHPC and HPC.

18. The film of claim 1, further comprising gum arabic.

19. The film of claim 1, further comprising a wax.

20. The film of claim 1, further comprising a flavorant.

21. The film of claim 1, further comprising a sweetener.

22. The film of claim 1, further comprising a disintegrant.

23. The film of claim 1, further comprising a non-ionic surfactant.

24. The film of claim 1, further comprising one or both of a pigment and a dye.

25. The film of claim 24, wherein said dye is present in an amount at least 0.1% by weight to provide a persistent stain.

26. (canceled)

27. (canceled)

28. The film of claim 1, further comprising sodium hexametaphosphate.

29. A water-soluble film, comprising an acidulent, a salt of alginic acid, and a sequestrant present in an amount up to about 6 wt. %.

30. The film of claim 13, wherein the sequestrant comprises sodium hexametaphosphate.

31. The film of claim 29, wherein the sequestrant is present in an amount of about 1 wt. % to about 4 wt. %.

32. The film of claim 29, further comprising a flavorant and a sweetener.

33. The film of claim 29, wherein said acidulent comprises one or more of a salt of an organic acid, an inorganic acid, a salt of an inorganic acid, and combinations thereof.

34. The film of claim 29, wherein said acidulent comprises an organic acid in an amount greater than 12 wt. %.

35. A water-soluble film, comprising an acidulent and an ester of alginic acid.

36. The film of claim 35, further comprising a sequestrant.

37. The film of claim 36, wherein the sequestrant comprises a salt of phosphoric acid or a salt of citric acid.

38. The film of claim 37, wherein the sequestrant comprises sodium hexametaphosphate.

39. The film of claim 36, wherein the sequestrant is present in an amount of about 1 wt. % to about 4 wt. %.

40. The film of claim 36, further comprising a flavorant and a sweetener.

41. The film of claim 36, wherein said acidulent comprises one or more of a salt of an organic acid, an inorganic acid, a salt of an inorganic acid, and combinations thereof.

42. The film of claim 36, wherein said acidulent comprises an organic acid in an amount greater than 12 wt. %.
